(19) United States
(12) Patent Application Publication
(10) Pub. No.: US 2015/0067108 A1
(43) Pub. Date: Mar. 5, 2015

(54) DATA RATE CONTROL OF INDIVIDUAL DATA STREAMS IN A NETWORK DEVICE

(71) Applicant: Broadcom Corporation, Irvine, CA (US)

(72) Inventors: Rajesh Shankarrao MAMIDWAR, San Diego, CA (US); Darren Duane NEUMAN, Palo Alto, CA (US); Anand TONGLE, San Diego, CA (US); David WU, San Diego, CA (US)

(73) Assignee: Broadcom Corporation, Irvine, CA (US)

(21) Appl. No.: 14/071,594

(22) Filed: Nov. 4, 2013

Related U.S. Application Data
(60) Provisional application No. 61/872,596, filed on Aug. 30, 2013.

(51) Int. Cl. H04L 12/815; H04L 29/06

(52) U.S. Cl. CPC H04L 47/22; H04L 65/4069
USPC 709/219

(57) ABSTRACT

A method includes receiving data stream packets on respective ones of data channels. The data stream packets of each respective data channel contain an input data stream. The method includes storing the data stream packets for each of the data channels in one or more packet buffers associated with the respective data channel. For each of the data channels, the method includes determining if a timing maturity event of a corresponding input data stream has occurred. The method includes outputting one or more of the stored data stream packets from the packet buffers associated with the respective data channel to generate a transmission packet if the timing maturity event of the corresponding input data stream has occurred. The stored data stream packets for generating consecutive transmissions packets may be output at a data rate based on a distance between timing maturity event occurrences of the corresponding input data stream.

### CROSS-REFERENCE TO RELATED APPLICATIONS

The present application claims the benefit of U.S. Provisional Patent Application Ser. No. 61/872,596, titled “DATA RATE CONTROL OF INDIVIDUAL DATA STREAMS IN A NETWORK DEVICE,” filed on Aug. 30, 2013, which is hereby incorporated by reference in its entirety for all purposes.

### TECHNICAL FIELD

The present description relates to data stream flow management, and more particularly, but not exclusively, to data rate control of individual data streams.

### BACKGROUND

A gateway device, such as a set-top box (STB) gateway, may provide audio/visual (AV) streams to client devices at multiple bit rates (e.g., from 1-2 Megabits-per-second (Mbps) for a mobile device to 30-35 Mbps for a 4K television). However, when multiple AV streams are sent to multiple clients via an Internet Protocol (IP) network, the operating system (OS) networking stack (e.g., TCP/IP) aggregates each AV stream in a single buffer, thereby creating bursty AV traffic of Ethernet packets on the IP network irrespective of the required data rates of the individual AV streams.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example network environment in which a system for data rate control of individual streams may be implemented, in accordance with various aspects of the subject technology.

FIG. 2 illustrates an example of a network device, in accordance with various aspects of the subject technology.

FIG. 3 is a block diagram illustrating components for controlling data rates of individual streams in the network device of FIG. 2, in accordance with various aspects of the subject technology.

FIG. 4 is a timing diagram illustrating an example of a data rate control between data channels in the network device of FIG. 2, in accordance with various aspects of the subject technology.

FIG. 5 illustrates an example of a method for controlling data rates of individual streams, in accordance with various aspects of the subject technology.

FIG. 6 conceptually illustrates an electronic system with which aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

In one or more approaches of OS network stack based IP transmissions, a large chunk of video data (e.g., 128 Kilo bytes or more of data) is collected in a buffer, which then receives encryption from the OS network stack. The OS network stack parses the large chunk of data into network packets (e.g., 1.5 Kilo bytes each), which causes “bursty” traffic of network packets on the IP network. As such, the subject disclosure provides a data rate control module and method to create transmission packets (e.g., Ethernet packets, IP packets) having a specified pace between consecutive packets to be provided to the IP network such that an average distance between the packets is based on the required data rate of the individual AV streams. As used herein, the term “buffer” can sometimes be referred to as a data structure (or similar memory structure) that contains the data.

In some implementations, a method of controlling data rates of individual streams is provided. The method may include receiving data stream packets on respective ones of data channels, in which the data stream packets of the respective ones of the data channels contain an input transport stream. The method also may include storing the data stream packets for each of the respective ones of the data channels in one or more packet buffers associated with the respective data channel; for each of the data channels, determining if a timing maturity event of a corresponding input transport stream has occurred; and outputting one or more of the stored data stream packets from the one or more packet buffers associated with the respective data channel to generate a transmission packet if the timing maturity event of the corresponding input transport stream has occurred. In some aspects, the stored data stream packets for generating consecutive transmissions packets are output at a data rate based on a distance between timing maturity event occurrences of the corresponding input transport stream.

The pacing of the transmission packets can be performed at the source of the AV data irrespective of the downstream link data rate, and hence, the burstiness on the downstream link associated with the OS networking stack can be avoided. In this respect, the actual IP network bandwidth can be distributed based on the program data rate requirements. Furthermore, by reducing the burstiness of the AV traffic on the downstream link, the size of buffers at the client devices can be decreased.

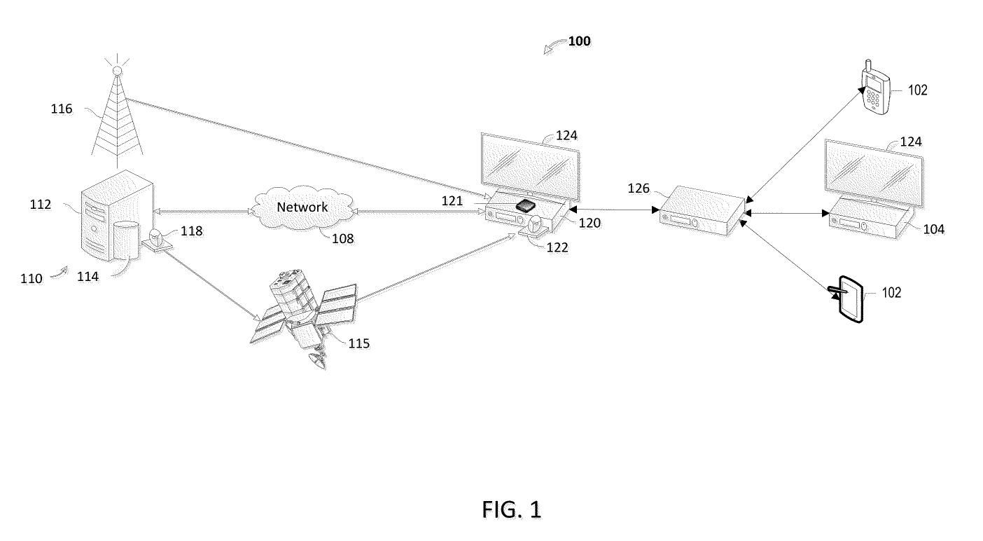

FIG. 1 illustrates an example network environment in which a system for data rate control of individual streams may be implemented, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The example network environment 100 includes a content delivery network (CDN) 110 that is communicably coupled to a gateway device 120, such as by a network 108. In one or more implementations, the network environment 100 may further include one or more electronic devices 102, 104, 106 that are communicably coupled to the gateway device 120 via an intermediate node device 126. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like. In one or more implementations, the network 108 may include one or more transmission networks, such as a coaxial transmission network, a fiber optic transmission network, or generally any transmission network that communicatively couples the content server 112 and the gateway device 120.

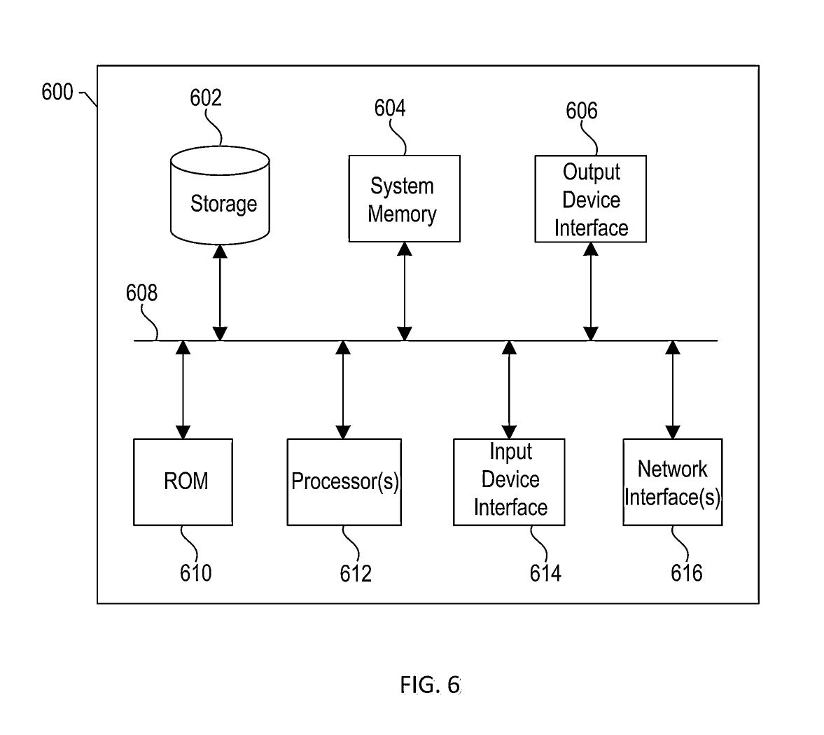

The CDN 110 may include, and/or may be communicably coupled to, a content server 112, an antenna 116 for transmitting AV streams, such as via multiplexed bitstreams, over the air, and a satellite transmitting device 118 that transmits AV streams, such as via multiplexed bitstreams to a satellite 115. The gateway device 120 may include, and/or may be coupled to, a satellite receiving device 122, such as a satellite dish, that receives data streams, such as multiplexed bitstreams, from the satellite 115. In one or more implementations, the gateway device 120 may further include an antenna for receiving data streams, such as multiplexed bitstreams over the air from the antenna 116 of the CDN 110. In one or more implementations, the content server 112 may transmit AV streams to the gateway device 120 over the coaxial transmission network, such as by utilizing technology implementing the Data Over Cable Service Interface Specification (DOC SIS). The content server 112 and/or the gateway device 120, may be, or may include, one or more components of the electronic system discussed below with respect to FIG. 6.

The content server 112 may include, or may be coupled to, one or more processing devices and/or a data store 114. The one or more processing devices execute computer instructions stored in the data store 114, for example, to implement a content delivery network. The data store 114 may store the computer instructions on a non-transitory computer-readable medium. The data store 114 may further store one or more programs, e.g. video and/or audio streams that are delivered by the CDN 110. In one or more implementations, the content server 112 may be a single computing device such as a computer server. Alternatively, the content server 112 may represent multiple computing devices that are working together to perform the actions of a server computer (such as a cloud of computers and/or a distributed system). The content server 112 may be coupled with various databases, storage services, or other computing devices, that may be collocated with the content server 112 or may be disparately located from the content server 112.

The content server 112 may transmit AV streams that include AV programs, such as television programs, movies, radio programs, podcasts, music, or generally any multimedia programs, via the network 108, the antenna 116, and/or the satellite 115. For example, the content server 112 may transmit Internet Protocol (IP) streams, such as unicast streams, such as adaptive bit rate (ABR) streams, multicast streams, and/or broadcast streams, that include AV streams over the network 108 and the content server 112 may transmit QAM-modulated and/or multiplexed bitstreams that include AV streams via the coaxial transmission line, the antenna 116 and/or the satellite 115, e.g. through the satellite transmitting device 118. In one or more implementations, any network data transmissions that include AV streams and/or AV data, and/or are associated with AV streams and/or AV data, such as acknowledgments for AV streams, may be referred to as AV traffic (or AV network traffic). Similarly, any network data transmissions that do not include, and/or are not associated with, AV streams and/or AV data, may be referred to as non-AV traffic (or non-AV network traffic).

The gateway device 120 may include, or may be coupled to, memory, a host processor for processing non-AV traffic, and a dedicated processor, along with associated hardware/firmware, that exclusively processes AV traffic, e.g. an AV stream processor, an AV processor or a stream processor. In one or more implementations, gateway device 120 may include a switch device that can be configured to route non-AV traffic to the host processor and AV traffic to the AV stream processor. Thus, in gateway device 120, AV traffic processing by the AV stream processor is decoupled from non-AV traffic processing by the host processor. In one or more implementations, the gateway device 120 may also be, or may also include, a set-top box, e.g. a device that is coupled to, and is capable of presenting AV programs on, an output device 124, such as a television, a monitor, speakers, or any device capable of presenting AV programs. In one or more implementations, the gateway device 120 may be integrated into the output device 124. The gateway device 120 may receive AV streams from the content server 112, such as multiplexed bitstreams, that include AV programs, such as television programs, movies, or generally any AV content. The gateway device 120 may receive the AV streams from the content server 112 via the antenna 116, via the network 108, and/or via the satellite 115.

In the example network environment 100 of FIG. 1, the gateway device 120 is configured to couple the electronic devices 102, 104, 106 to the content server 112 and/or to the network 108, e.g. by using the aforementioned switch device. For example, the gateway device 120 may receive requests for AV traffic from the electronic devices 102, 104, 106 via the intermediate node device 126 and may forward the requests to the content server 112. In response to the requests, the gateway device 120 may receive AV traffic from the content server 112 and may forward the AV traffic to the intermediate node device 126 to forward to one or more of the electronic devices 102, 104, 106. In one or more implementations, the gateway device 120 may receive and/or retrieve AV streams via one or more local AV sources, such as a local hard drive and/or one or more local AV tuners. For example, the electronic devices 102, 104, 106 may record AV programs on the local hard drive of the gateway device 120. The gateway device 120 may then provide the recorded AV programs to the electronic devices 102, 104, 106 for playback, e.g. in response to the requests therefore.

The intermediate node device 126 may include, or may be coupled to, memory and a switch device that can be configured to route non-AV traffic and/or AV traffic to the electronic devices 102, 104 106. The intermediate node device 126 may receive the non-AV streams and/or AV streams from the gateway device 120. In some aspects, the switch device of the intermediate node device 126 is configured to operate at data rates (e.g., Megabit/sec) that are lower than data rates (e.g., Gigabit/sec) of the switch device in the gateway device 120. By way of example, the switch device of the gateway device 120 may be operative at gigabit rates whereas the switch device of the intermediate node 126 may be operative at megabit rates.

In the example network environment 100 of FIG. 1, the intermediate node device 126 is configured to couple the electronic devices 102, 104, 106 to the gateway device 120, e.g. by using the aforementioned switch device. For example, the intermediate node device 126 may receive requests for AV traffic from the electronic devices 102, 104, 106 and may forward the requests to the gateway device 120. In response to the requests, the gateway device 120 may receive AV traffic from the content server 112 and may forward the AV traffic to the intermediate node device 126 to forward to one or more of the electronic devices 102, 104, 106.

The electronic devices 102, 104 and 106 can be computing devices such as laptop or desktop computers, smartphones, personal digital assistants (“PDAs”), portable media players, set-top boxes, tablet computers, televisions or other displays with one or more processors coupled thereto and/or embedded therein, or other appropriate computing devices that can be used for receiving, decoding, and presenting of AV programs and/or can be coupled to such a device. In the example of FIG. 1, electronic device 102 is depicted as a smart phone, electronic device 104 is depicted as a desktop computer, and electronic device 106 is depicted as a tablet device. In one or more implementations, any of electronic devices 102, 104, 106 may be referred to as a user device or a client device. In certain aspects, the electronic devices 102, 104, 106 have different bit rate requirements.

In operation, any of the streams transmitted by the content server 112 may be transport streams, such as MPEG transport streams, MPEG-2 transport streams, and the like, and/or any of the streams may be program streams, such as MPEG program streams, MPEG-2 program streams, and the like. For example, the content server 112 of the CDN 110 may packetize the video frames of video streams and/or audio frames of audio streams, into packetized elementary stream (PES) packets. Thus, each PES packet may include one video frame (or audio frame), and the PES packets may be variable sized to account for the varying sizes of different types of video frames, e.g. I-frames, B-frames, P-frames, etc. The header of a PES packet may include a time stamp that indicates when the video frame and/or audio frame contained in the PES packet should be decoded and presented, such as presentation time stamps (PTS), decoding time stamps (DTS), transmitter time stamps (TTS), descriptor time stamps or generally any time stamps. The header of a PES packet may further include an elementary stream clock reference (ESCR) that may be used to synchronize the system time clock of the content server 112 with the system time clock of a receiving device, such as the gateway device 120. In one or more implementations, a program stream may include a group of tightly coupled PES packets referenced to the same time base, which may be indicated in the program stream by a system clock reference (SCR). Similar to the ESCR, the SCR may be used to synchronize the system time clock of the content server 112 with the system time clock of a receiving device, such as the gateway device 120.

The content server 112 may then segment and encapsulate the PES packets into data stream packets, such as MPEG transport stream packets, which may be a fixed size, such as 188-byte packets, 192-byte packets, or generally any size packets. In certain aspects, the data stream packets include AV streams, non-AV streams, transport streams and/or non-transport streams.

In one or more implementations, the AV streams may be encapsulated in any transport stream packets. The header of a transport stream packet may include one or more data fields pertaining to the payload of the transport stream packet, such as a program clock reference (PCR). Similarly to the ESCR and the SCR, the PCR may be used to synchronize the system time clock of the content server 112 with the system time clock of a receiving device, such as electronic devices 102, 104, 106, and/or gateway device 120. The header of a transport stream packet may also include a continuity counter value that is incremented for each transport stream packet for which a payload is present. The header of the transport stream packet may also include a payload unit start indicator (PUSI) bit which may be set to 1 if the transport stream packet includes the start of a PES packet, which also coincides with the start of an audio frame and/or video frame. Thus, the PUSI bit indicates whether the transport stream packet includes the start of an audio frame and/or video frame. In one or more implementations, the content server 112 may encrypt the payloads of the transport stream packets, but not the headers of the transport stream packets, e.g. using a conditional access (CA) system. In one or more implementations, the content server 112 may further encapsulate the transport stream packets into internet protocol (IP) packets, e.g. for transmission over the network 108.

The gateway device 120 may receive the transport stream packets and/or IP packets that include the transport stream packets, and may decode and/or decrypt the transport stream packets to recover the AV stream. For local playback, e.g. on the output device 124, the gateway device 120 may identify a random access point in the AV stream, may decode the AV stream starting at the random access point, and may present the AV stream on the output device 124. In one or more implementations an AV stream may refer to an audio stream and/or a video stream.

The gateway device 120 may also prepare the received transport stream packets for transmission to one or more of the electronic devices 102, 104, 106, such as by encrypting the transport stream packets, and/or packetizing the transport stream packets, e.g. into IP packets. The gateway device 120 may then transmit the packets to one or more of the electronic devices 102, 104, 106. In one or more implementations, the gateway device 120 may modify the AV stream contained in the transport stream packets, e.g. dropping one or more audio and/or video frames of the AV stream by dropping the corresponding transport stream packets, adding one or more audio and/or video frames to the AV stream by adding corresponding transport stream packets, replacing one or more audio and/or video frames of the AV stream by replacing the corresponding transport stream packets, and/or modifying timing parameters of the transport stream packets, before encrypting and packetizing the transport stream packets for transmission to the electronic devices 102, 104, 106. Since the AV stream processor of the gateway device 120 can access the transport stream packets and/or PES packets “in the clear,” e.g. without encryption, the AV stream processor of the gateway device 120 may have access to, and be able to modify and/or replace, audio and/or video frames of the AV stream.

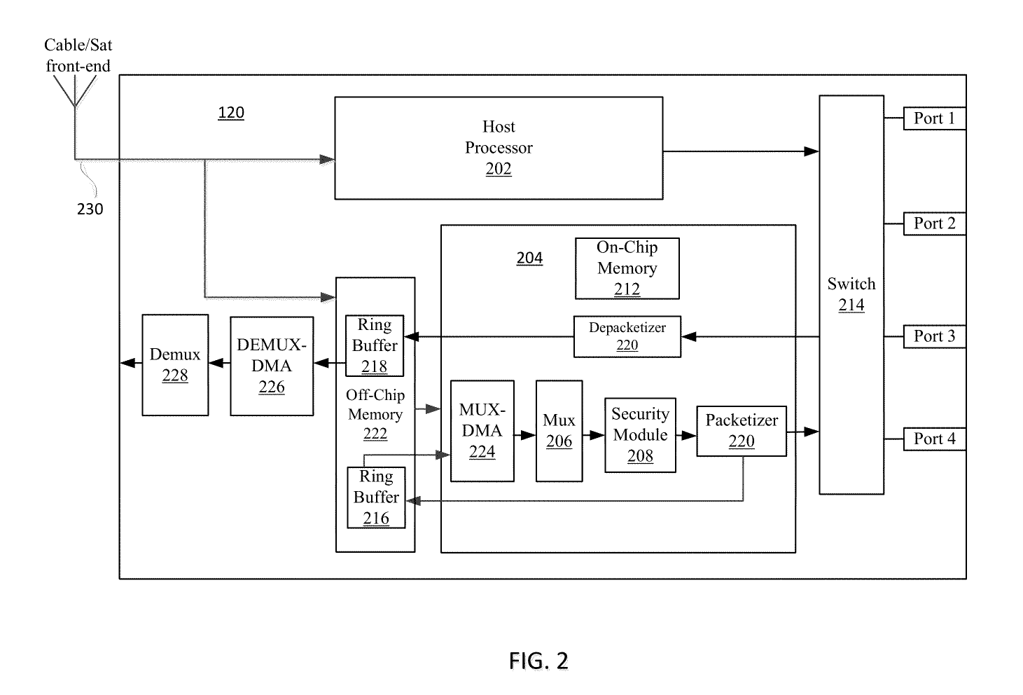

Conventionally, audio-video (AV) stream rates are lower (e.g. ˜1-20 Mbps) compared to the physical interface of a streaming device (e.g. 100 Mbps to 1 Gigabit per second (Gbps)). During AV streaming, many conventional approaches include sending bursts of hundreds of Kilobytes (KB) of AV data from every stream source at gigabit rates, e.g., Gigabit/sec link rate. However, if there are some lower speed links between networking devices, burstiness from a source can cause network congestion on the lower speed links, and cause packet loss on the network. As such, rate smoothing at the source for each data stream, as will be described in FIGS. 2-5, can avoid network congestion on the network.

FIG. 2 illustrates an example of a network device, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The gateway device 120 is provided that includes a host processor 202 and a dedicated processor and associated hardware and firmware that exclusively handle AV network traffic, e.g., an advanced stream processor (ASP) 204, for efficient network processing of AV network traffic in addition to host processor 202 that handles non-AV network traffic. ASP 204 is configured to process AV network traffic e.g., packets or traffic that include or are related to AV data, over one or more channels. An entity, e.g. a software entity, running on host processor 202 is configured to work in conjunction with a network switch (e.g., switch 214) to receive and route the network traffic to either ASP 204 or host processor 202, depending on whether the network traffic includes AV network traffic or non-AV network traffic. Accordingly, ASP 204 exclusively handles network connections associated with AV network traffic while host processor 202 handles network connections corresponding to non-AV network traffic, thereby offloading a significant amount of processing from host processor 202 to ASP 204.

Since ASP 204 operates as a dedicated engine, separate from host processor 202, ASP 204 can access the video transport streams of the AV network traffic “in the clear,” e.g. free of any encryption or other digital rights management (DRM) mechanisms, while host processor 202 can only access the encrypted or otherwise protected AV transport streams. Thus, ASP 204 can access parameters and values associated with the video transport streams (e.g., MPEG parameters), such as transmitter timestamp (TTS) values, presentation time stamp (PTS) values, PCR values, continuity counter values, or descriptor timestamp values to avoid burstiness on downstream link to electronic devices 102, 104, 106. In some aspects, the PCR values represent a periodically transmitted value to assure that the audio portion matches the video portion of the AV network traffic. In certain aspects, the TTS values represent a clock value transmitted at each packet-to-packet boundary. In one or more implementations, the descriptor timestamp values represent a mechanism to inform hardware (e.g., from software or firmware implementations) that data stream packets are ready for packet processing. If there are no MPEG parameters accessible to control data rates, rates approximate to 20-30 Megabits per second can be configured on a 1 Gigabit per second downstream link, for example, and avoid bursts at gigabit rates. In this regard, per flow rate smoothing without MPEG timing control fields can be achieved.

In addition, ASP 204 can access transmission parameters and data type values associated with outgoing AV transport streams. Accordingly, ASP 204 may be able to perform retransmission handling of individual AV transport streams as well as memory consumption tracking, since ASP 204 can access the parameters and values carried by the AV transport streams (even when received encrypted), whereas host processor 202 alone is unable to perform data rate control of the AV transport streams when they are received encrypted.

As shown in FIG. 2, ASP 204 may receive AV network traffic from the cable/satellite front-end 230, while host processor 202 may receive non-AV network traffic from the cable/satellite front-end. The cable/satellite front end 230 may include one or more other devices and/or connections for receiving AV content via a coaxial transmission network, via satellite, via antenna, and/or via any other transmission network. ASP 204 may receive AV network traffic from encoders (not shown) or an AV storage device (not shown).

Gateway device 120 also includes switch 214 that receives the processed AV network traffic from ASP 204 and/or the processed non-AV network traffic from host processor 202. Switch 214 may route this traffic to their intended destinations via one or more ports (e.g., shown in FIG. 2 as port 2, port 2, port 3, and port 4) that may be coupled to one or more physical network ports, such as an Ethernet physical layer (PHY) port, a multimedia over coax alliance (MoCA) port, a Powerline port, or reduced gigabit media independent interface (RGMII) port. The destinations may include one or more downstream client devices operably connected to gateway device 120, such as different set top clients, televisions, tablets, laptop computers, desktop computers, mobile phones, or any suitable computing device for receiving the AV network traffic. In one or more implementations, switch 214 may be integrated on-chip. Although gateway device 120 is illustrated as including components for facilitating data flow from the processors to switch 214, it is understood that gateway device 120 may include other components (not shown) for facilitating data flow in the opposite direction (e.g., from switch 214 to the processors). In certain aspects, gateway device 120 does not include switch 214 such that the burstiness of the AV traffic downstream can be reduced without any switch requirement.

ASP 204 includes multiplexer 206, security module 208, packetizer 210, on-chip memory 212, depacketizer 220 and MUX-DMA (multiplexer-direct memory access) 224. Multiplexer 206 may receive AV data units (e.g., transport stream packets) via MUX-DMA 224, and store the AV data units in on-chip memory 212, off-chip memory 222 (e.g., random access memory such as dynamic random access memory (DRAM)), and/or other suitable locations. Gateway device 120 also includes DEMUX-DMA 226 and Demultiplexer 228. Demultiplexer 228 may receive AV data or non-AV data from off-chip memory 222 via DEMUX-DMA (demultiplexer-direct memory access) 226. In some aspects, Demultiplexer 228 receives an output from ring buffer 218.

As shown in FIG. 2, Multiplexer 206 receives data channels carrying different data types. By way of example, Multiplexer 206 can receive transport stream packets marked for regular transmission, and in addition, Multiplexer 206 can receive a retransmission payload marked for retransmission carried on separate dedicated channels. As such, Multiplexer 206 acts as a single point of entry for all AV streams including packets marked for retransmission. In this respect, the rate of each AV stream entering Multiplexer 206 can be individually controlled and substantially lossless transmission of the AV packets can be provided.

Security module 208 may encrypt or otherwise apply security to the data units received from Multiplexer 206. Security module 208 may include an encryption unit that encrypts or otherwise applies security to the data units received from Multiplexer 206. Security module 208 also may include buffers for storing the data units.

Packetizer 210 (e.g., an Ethernet packetizer) may receive the data units from security module 208 and packetize the data units (e.g., encapsulate the data units in a payload and add headers to generate packets of data for transmission). Packetizer 210 may include one or more packetizing units that packetize the data units. Packetizer 210 also may include buffers for storing the packetized data units. Packetizer 210 also may include an output unit that distributes the packetized data units to switch 214. In one or more implementations, packetizer 210 generates Ethernet frames to be transmitted by gateway device 120. For example, static header information corresponding to each channel for transmission may be stored in off-chip memory, such as DRAM, or in on-chip memory, such as on-chip buffer 212. The static header information may include Ethernet header information, IP header information, and/or TCP/UDP/RTP header information. Packetizer 210 retrieves the static header information from memory, adds dynamic header information (e.g., sequence number, incremental time stamps, etc.), and packages the payload data (e.g., retrieved from DRAM) to generate an Ethernet frame for transmission. Thus, according to certain aspects, the subject system provides for a single framing stage, rather than multiple stages for each header. Switch 214 may receive the packets of data from packetizer 210 and route the packets to their intended destinations.

The depacketizer 220 may extract headers from the packets based at least on the channels associated with the packets, e.g. based on header processing configuration information for each channel that is stored in the on-chip memory 212. The depacketizer 220 may generate a header information item from each extracted header. A header information item may be a data structure that includes information extracted from the header of the packet and that also includes the size of the payload of the packet, and memory location information for accessing the payload in the off-chip memory 222, e.g. the starting address at which the payload will be stored in the off-chip memory 222.

Switch 214 may include a packet forwarding engine that receives the data units from an output unit and places them in corresponding outbound queues. From the outbound queues, the data units may be routed to their intended destinations. Each of the outbound queues may be associated with a corresponding buffer. For example, a data unit stored in a buffer associated with a first channel may be placed in a corresponding outbound queue for the first channel. According to certain aspects, one or more of the outbound queues may be dedicated for storing AV traffic. The outbound queues dedicated for storing AV traffic may have higher priority for scheduling transmissions than outbound queues for storing non-AV traffic.

The off-chip memory 222 may be, or may include, one or more memory modules, such as dynamic random-access memory (DRAM), double data rate synchronous dynamic random-access memory (DDR SDRAM), and/or any other suitable memory modules. For explanatory purposes, the off-chip memory 222 is illustrated as a single block; however, the off-chip memory 222 may be, and/or may include, several separate individual memory modules, or several separate partitions of one or more memory modules. In one or more implementations, the off-chip memory 222 may be referred to as “off-chip” because the memory modules of the off-chip memory 222 may be on a separate semiconductor chip than the AV stream processor 204 and the components thereof, e.g. the memory modules of the off-chip memory 222 may be external to the AV stream processor 204 and consequently the components thereof. In one or more implementations, the off-chip memory 222 may be on the same PCB, or a different PCB, as the AV stream processor 204. In certain aspects, the off-chip memory 222 does not include ring buffers 216 and 218 such that protocols, such as UDP/RTP, can be facilitated by the gateway device 120 without any ring buffer requirement.

Ring buffers 216 and 218 may be data structures configured to use a single, fixed-size buffer for each AV channel as if ring buffers 216 and 218 were connected end-to-end. Ring buffers 216 and 218 may sometimes be referred to as circular buffers or cyclic buffers. In some aspects, ring buffers 216 and 218 are non-circular buffers. In some aspects, ring buffers 216 and 218 are implemented in off-chip memory 222. In certain aspects, ring buffers 216 and 218 are implemented in on-chip memory 212 and/or other suitable locations.

Ring buffer 216 may include multiple buffers, one for each AV channel for transmission. Ring buffer 216 may receive the packetized data units from packetizer 210 and store the packetized data units. In this respect, ring buffer 216 may be allocated to every AV stream, and the transmitted AV data of each AV stream is continuously stored in ring buffer 216.

Similarly, ring buffer 218 may include multiple buffers, one for each AV channel for reception. Ring buffer 218 may receive depacketized data units from depacketizer 220 and store the depacketized data units in a specified received order (e.g., arrival order) or in a specified arranged order (e.g., sequential order).

In one or more implementations, several pacing techniques are performed depending on implementation. The distance between consecutive transmission packets, for example, can be controlled using a fixed counter value. In some aspects, time stamps are attached to an input data stream such as an input data stream. In this respect, the time stamps may indicate a specified timing that needs to be retained between the packets. ASP 204 may be configured to parse the time stamps and provide control signaling to Multiplexer 206 to keep the distance between the packets based on the parsed time stamps.

PCR values may be present in the input data stream. In this regard, the PCR values may indicate a specified distance that needs to be retained between the packets containing PCR values. ASP 204 may be configured to parse the PCR values and provide control signaling to Multiplexer 206 to retain the required distance between the transmission packets containing PCR values based on the parsed PCR values.

In some aspects, incoming AV streams contain descriptors. Such descriptors may contain time stamps that indicate a specified time at which a first chunk of data allocated by a respective descriptor needs to be released to the IP network, including a specified time distance between remaining chunks of data associated with respective descriptors.

The foregoing pacing techniques may enable gateway device 120 to recapture any lost bandwidth in one or more IP transmissions. In this regard, if the IP network is stalled and the release times of the packets have past, one or more of the pacing techniques can be performed to release the transmission packets that have reached timing maturity at a faster pace than the aforementioned approaches (e.g., via the OS networking stack). In this respect, the pacing techniques can control the distance between the transmission packets based on the dynamic release times (e.g., output from the packet buffers at specified times). In some aspects, various combinations of the aforementioned pacing techniques can be performed on a same AV stream. When activated simultaneously, the data stream packets for generating a transmission packet may be released only when all the different types of pacing mechanisms indicate that the timing to release the data streams packets has matured.

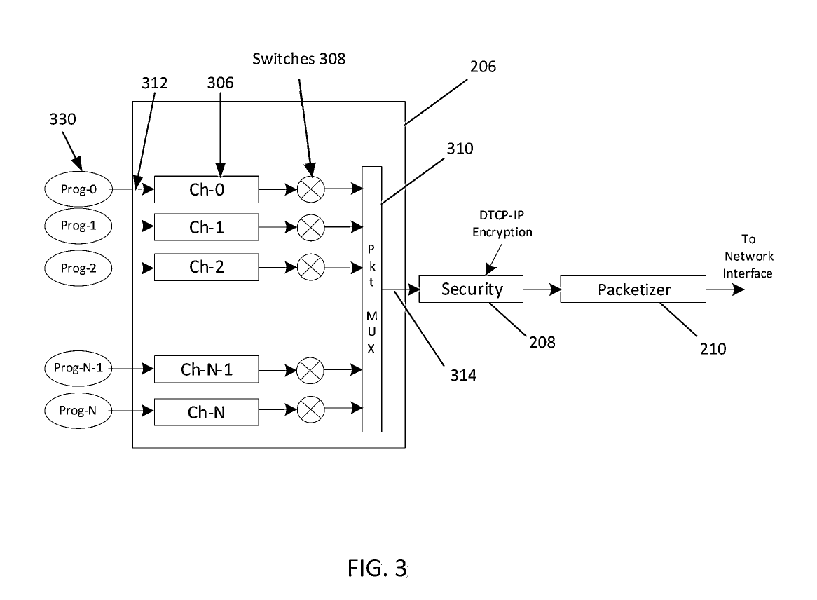

FIG. 3 is a block diagram 300 illustrating components for controlling data rates of individual streams in the network device of FIG. 2, in accordance with various aspects of the subject technology. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

Multiplexer 206 is coupled to data unit module 330 that receives and/or generates data units intended to be transmitted to a network interface, such as a switch, an Ethernet physical layer (PHY) port, a multimedia over coax alliance (MoCA) port, a Powerline port, or reduced gigabit media independent interface (RGMII) port, so that the data units can be provided to downstream client devices, such as electronic devices 102, 104, 106 (FIG. 1). Data unit module 330 may place the data units in buffers 306, each of which may be associated with a corresponding channel. Buffers 306 may be part of on-chip memory 212 (FIG. 2), off-chip memory 222 (e.g., DRAM), and/or other memory. Buffers 306 may be the last location at which data units are stored before Multiplexer 206 transmits the data units to a next stage (e.g., security module 208 of FIG. 2). Multiplexer 206 includes multiplexer 310, which is coupled to buffers 306 via switches 308. Multiplexer 310 multiplexes the data units from buffers 306 and transmits them to security module 208. In some aspects, Multiplexer 206 includes an admission control handler (not shown), which may control switches 308 to release data units stored in buffers 306 to multiplexer 310, thereby allowing multiplexer 310 to transmit the data units to security module 208.

In some aspects, Multiplexer 206 includes input data paths 312 associated with respective data channels coupled to input ports of Multiplexer 206 and packet buffers 306. Multiplexer 206 also may include output data path 314 coupled to an output of multiplexer 310 to an output port of Multiplexer 206. Packet buffers 306 are configured to receive and store data stream packets, such as transport stream packets, AV data (e.g., ES, PES), and/or any raw data format, received via the respective ones of input data paths 312. The data stream packets for each respective data channel may include an input data stream. Control switches 308 are coupled to an output of respective ones of packet buffers 306 and configured to determine, for each of the data channels, if a timing maturity event of a corresponding input data stream has occurred. Multiplexer 310 is coupled to outputs of control switches 308 and output data path 314. Multiplexer 310 is configured to output one or more of the stored data stream packets from one or more packet buffers 306 associated with the respective data channel for generating a transmission packet (e.g., Ethernet packet) if the timing maturity event of the corresponding input data stream has occurred. The stored data stream packets for generating consecutive transmissions packets may be output at a data rate based on a distance between timing maturity event occurrences of the corresponding input data stream.

In some implementations, the one or more packet buffers 306 associated with the respective data channel retrieve remaining data stream packets of the corresponding input data stream from a memory (e.g., on-chip memory 212) until a threshold number of packets has been reached. In this regard, the remaining data stream packets may be retrieved while multiplexer 310 outputs the stored data stream packets to output data path 314. In some aspects, the threshold number of packets corresponds to a payload size of the transmission packet.

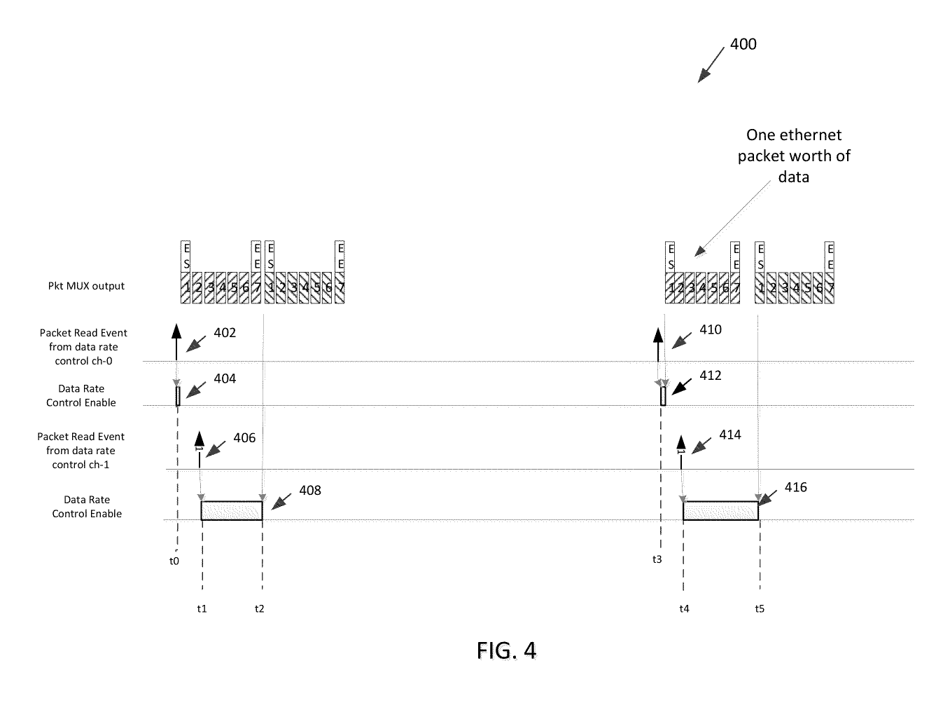

FIG. 4 is a timing diagram 400 illustrating an example of a data rate control between data channels in the network device of FIG. 1, in accordance with various aspects of the subject technology. Timing diagram 400 shows timing relationships between a packet read event from a data rate control of a first data channel, a data rate control enable of the first data channel, a packet read event from a data rate control of a second data channel and a data rate control enable of the second data channel. As such, timing diagram 400 includes packet read event signals 403, 406, 410 and 414, and data rate control enable signals 404, 408, 412 and 416.

Switches 308 include logic and/or circuitry to determine when a corresponding data channel is available to release data onto the IP network. Particularly, switches 308 can employ a counter that counts downward to a fixed counter value indicating a point of time maturity for the corresponding data channel. By way of example, one of switches 308 can provide a first indication (e.g., packet read event signal 403) of a first timing maturity event occurrence at time t0 for one of the plurality of data channels (e.g., channel 0). In some aspects, the first indication provides for selection of the respective data channel containing the corresponding input data stream having the first timing maturity event occurrence. For example, multiplexer 310 may be configured to select channel 0 to release the stored packets from buffers 306 if packet read event signal 403 is triggered high (logical “1”). In some aspects, a payload length of data is released for encryption and packetization. In this respect, the number of packets released that constitute the payload length of data may vary depending on implementation. Here, seven (7) data stream packets (or data units) are released to generate one transmission packet (e.g., Ethernet packet). In certain aspects, the data stream packets include AV streams, non-AV streams, transport streams and/or non-transport streams.

During the release of the data stream packets for channel 0, for example, a second indication (e.g., packet read event signal 406) may be triggered high indicating a second timing maturity event occurrence for a different one of the plurality of data channels (e.g., channel 1). Here, while at least the stored transport packets of the selected data channel (e.g., channel 0) having the first timing maturity event occurrence are being output, channel 1 has also reached time maturity. In this regard, the switch associated with channel 1, for example, may provide controls to multiplexer 310 for selecting channel 1 having the second timing maturity event occurrence until the threshold number of packets is reached in the currently selected data channel (e.g., channel 0).

Switches 308 may output control signals for each of the data channels indicating which data channels are available for selection. As shown in FIG. 4, a first control signal (e.g., data rate control enable 404) associated with a first data channel (e.g., channel 0) having the first timing maturity event occurrence is held logically low right after time t0 indicating that passage of data stream packets from channel 0 is allowed while a second control signal (e.g., data rate control enable 408) at time t1 associated with a second data channel (e.g., channel 1) having the second timing maturity event occurrence is held logically high indicating that passage of data stream packets from channel 1 is restricted. In some aspects, data rate control enable 408 is held logically high until the threshold number of packets is reached in the first data channel (e.g., at time t2), at which time the data stream packets on channel 1 can be released from packet buffers 306 on channel 1 for encryption and packetization.

For subsequent transmission packet generation, timing maturity for each data channel can be tracked and release of data for time-matured data channels can be controlled individually. Packet read event signal 410 at time t3 indicates that channel 0 has reached timing maturity and data rate control enable 412 is temporarily held logically high to denote that multiplexer 310 is available to release the data from channel 0 soon after the data is read from packet buffers 306 on channel 0. At time t4, channel 1 reaches timing maturity while data is being released on channel 0 based on the indication of packet read event signal 414. At this point, data rate control enable is triggered high and held at that state until multiplexer 310 has read out a payload length of data for packet generation. In this regard, data read control enable 416 is held high until time t5. At this point, data from channel 1 can be released until a threshold number of packets (e.g., seven) for channel 1 are reached to denote the payload length of a corresponding transmission packet.

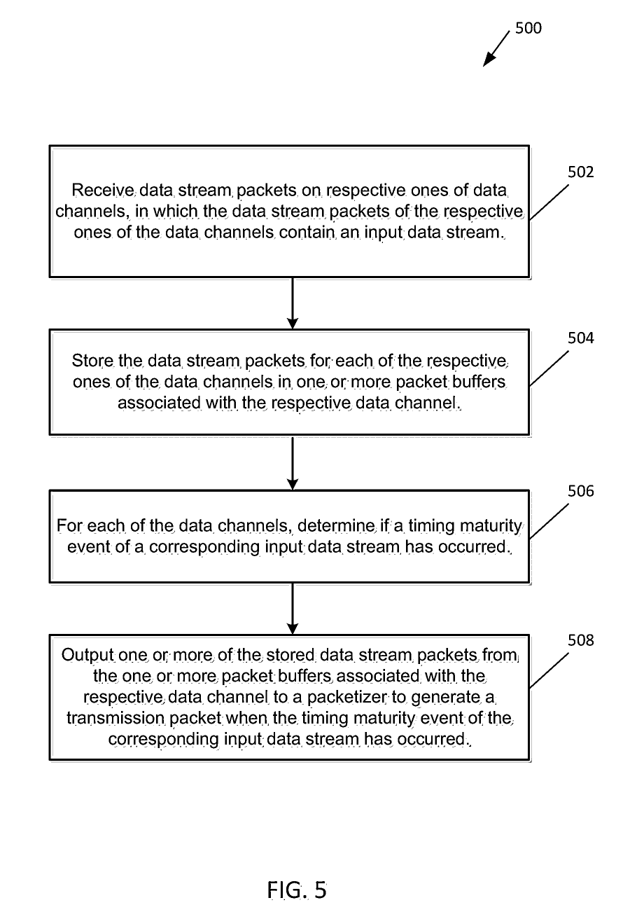

FIG. 5 illustrates a flowchart of a method 500 for controlling data rates of individual streams, in accordance with various aspects of the subject technology. Multiplexer 206 of FIG. 2, for example, may be used to implement method 500. However, method 500 may also be implemented by systems having other configurations. Although method 500 is described herein with reference to the examples of FIGS. 3 and 4, method 500 is not limited to these examples. Furthermore, although method 500 is illustrated in the order shown in FIG. 5, it is understood that method 500 may be implemented in a different order.

Method 500 includes processes S502, S504, S506 and S508. Processes S502 and S504 may be implemented by buffers 306. Process S506 may be implemented by switches 308. Process S508 may be implemented by multiplexer 310. Although the processes implemented by buffers 306, switches 308 and multiplexer 310 are described as being part of method 500, the processes implemented by buffers 306, switches 308 and multiplexer 310 may, in certain aspects, be considered as separate methods.

According to process S502, buffers 306 are configured to receive data stream packets on respective ones of data channels. The data stream packets of respective data channels include an input data stream. According to process S504, buffers 306 are configured to store the data stream packets for each of the respective ones of the data channels.

According to process S506, for each of the plurality of data channels, switches 308 are configured to determine if a timing maturity event of a corresponding input data stream has occurred. In determining if the timing maturity event of a corresponding input data stream has occurred, method 500 may include a process for obtaining an overhead portion of the stored data stream packets, retrieving pace information associated with the corresponding input data stream from the overhead portion, comparing the pace information with a specified counter value to determine a match, and determining a timing maturity event occurrence based on a match between the pace information and the specified counter value. In some aspects, the pace information is retrieved from a payload of the data stream packets.

In certain aspects, switches 308 may be configured to reset the specified counter value when the threshold number of packets is reached. In this regard, the specified counter value may be reset to zero (“0”) or a non-zero value. The specified counter value may include a single digit or multiple digits (or bits).

The process for determining the timing maturity event occurrence may include a sub-process for determining if a fixed counter value has expired. Alternatively, method 500 may include a process for determining if a fixed counter value has expired and the specified counter value has matched the pace information. In this regard, when activated simultaneously, the packets are released only when all the types of pacing mechanisms (e.g., fixed counter, TTS, PCR, descriptor) indicate that the timing has matured.

As part of process S506, the method may include a process for determining if a time distance is needed to retain between the consecutive transmission packets based on the pace information, parsing the pace information from the overhead portion into separate data rate control configurations, associating the separate data rate control configurations with respective ones of the consecutive transmission packets if the time distance is determined to be needed, and controlling output of the stored transport stream packets for corresponding ones of the consecutive transmission packets with the time distance between the consecutive transmission packets.

In some aspects, the pace information includes one of transmitter timestamp (TTS) values, program clock reference (PCR) values or descriptor timestamp values. In this respect, the process for retrieving the pace information may include a sub-process for determining if TTS values are attached to the corresponding input transport stream, in which the TTS values indicate a time distance necessary to retain between the consecutive transmission packets, parsing the TTS values from the overhead portion of the one or more of the stored transport stream packets, and associating the parsed TTS values with respective ones of the consecutive transmission packets. In certain aspects, the parsed TTS values include transmitter transmission times (e.g., time at which sent by transmitter). The process for comparing the pace information may include a sub-process for comparing the counter value with a specified transmitter transmission time against a respective one of the transmitter transmission times contained in the overhead portion of the stored transport stream packets.

In addition, the process for retrieving the pace information may include a sub-process for determining if PCR values are attached to the corresponding input transport stream. In some aspects, the PCR values indicate a time distance necessary to retain between the consecutive transmission packets. The sub-process may include parsing the PCR values from the overhead portion of the one or more of the stored transport stream packets and associating the parsed PCR values with respective ones of consecutive transmission packets containing PCR values. The process for comparing the pace information may include a sub-process for comparing the counter value with a specified program control reference clock against a respective one of the parsed PCR values.

Furthermore, the process for retrieving the pace information may include a sub-process for determining if the transport stream packets are received with descriptor timestamp values, in which the descriptor timestamp values indicate a time distance necessary to retain between consecutive data units of the corresponding input transport stream. In certain aspects, the descriptor timestamp values include a time at which a first data unit of the corresponding input transport stream has to be released from the one or more packet buffers 306. The process for comparing the pace information may include a sub-process for comparing the counter value with a specified descriptor timestamp value against a respective one of the descriptor timestamp values.

According to process S508, multiplexer 310 is configured to output one or more of the stored transport stream packets from the one or more packet buffers associated with the respective data channel to generate a transmission packet if the timing maturity event of the corresponding input transport stream has occurred. In some aspects, the stored transport stream packets for generating consecutive transmissions packets are output at a data rate based on a distance between timing maturity event occurrences of the corresponding input transport stream.

The process for outputting the one or more of the stored transport stream packets may include a sub-process for retrieving remaining transport stream packets of the corresponding input data stream from a memory (e.g., on-chip memory 212 of FIG. 2) until a threshold number of packets has been reached. In some aspects, the remaining transport stream packets are retrieved while the stored transport stream packets are being output by multiplexer 310.

FIG. 6 conceptually illustrates an electronic system 600 with which one or more implementations of the subject technology may be implemented. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

The electronic system 600, for example, can be a desktop computer, a laptop computer, a tablet computer, a server, a switch, a router, a base station, a receiver, a phone, a personal digital assistant (PDA), or generally any electronic device that transmits signals over a network. The electronic system 600 can be, and/or can be a part of gateway device 100 (FIG. 1). Such an electronic system 600 includes various types of computer readable media and interfaces for various other types of computer readable media. The electronic system 600 includes a bus 608, one or more processing unit(s) 612, a system memory 604, a read-only memory (ROM) 610, a permanent storage device 602, an input device interface 614, an output device interface 606, a local area network (LAN) interface 616, and a wide area network (WAN) interface 618, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a flash drive or a universal serial bus (USB) drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

In some aspects, the electronic system 600 includes a computer program product with instructions stored in a tangible computer-readable storage medium such as permanent storage device 602. The instructions may include instructions for receiving data stream packets on respective ones of data channels, in which the data stream packets of the respective ones of the data channels contain an input data stream. The instructions also may include instructions for storing the data stream packets for each of the respective ones of the data channels in one or more packet buffers associated with the respective data channel. The instructions also may include instructions for determining, for each of the data channels, if a timing maturity event of a corresponding input data stream has occurred. Further, the instructions also may include instructions for outputting one or more of the stored data stream packets from the one or more packet buffers associated with the respective data channel to generate a transmission packet if the timing maturity event of the corresponding input data stream has occurred. The stored data stream packets for generating consecutive transmissions packets may be output at a data rate based on a distance between timing maturity event occurrences of the corresponding input data stream. The data stream packets may represent AV data, non-AV data, transport streams and/or non-transport streams.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 608 also couples the electronic system 600 to a network (not shown) through the LAN interface 616 and separately, or jointly, through the WAN interface 618. In this manner, the electronic system 600 can be a part of a network of computers, such as a LAN through the LAN interface 616, a WAN through the WAN interface 618, an Intranet through either of the interfaces 616, 618, or a network of networks through either of the interfaces 616, 618, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method of controlling data rates of individual streams, the method comprising:
receiving a plurality of data stream packets on respective ones of a plurality of data channels, wherein the plurality of data stream packets of the respective ones of the plurality of data channels comprise an input data stream;
storing the plurality of data stream packets for each of the respective ones of the plurality of data channels in one or more packet buffers associated with the respective data channel;
for each of the plurality of data channels, determining if a timing maturity event of a corresponding input data stream has occurred; and
outputting one or more of the stored data stream packets from the one or more packet buffers associated with the respective data channel to generate a transmission packet if the timing maturity event of the corresponding input data stream has occurred,
wherein the stored data stream packets for generating consecutive transmissions packets are output at a data rate based on a distance between timing maturity event occurrences of the corresponding input data stream.

2. The method of claim 1, wherein outputting the one or more of the stored data stream packets comprises retrieving remaining data stream packets of the corresponding input data stream from a memory until a threshold number of packets has been reached, and wherein the remaining data stream packets are retrieved while the stored data stream packets are being output.

3. The method of claim 2, wherein determining if the timing maturity event of a corresponding input data stream has occurred comprises:
obtaining an overhead portion of the one or more of the stored data stream packets;
retrieving pace information associated with the corresponding input data stream from the overhead portion;
comparing the pace information with a specified counter value to determine a match; and
determining a timing maturity event occurrence based on a match between the pace information and the specified counter value.

4. The method of claim 3, further comprising:
providing a first indication of a first timing maturity event occurrence for one of the plurality of data channels, wherein the first indication provides for selection of the respective data channel containing the corresponding input data stream having the first timing maturity event occurrence.

5. The method of claim 4, further comprising:
providing a second indication of a second timing maturity event occurrence for a different one of the plurality of data channels while at least the stored data stream packets of the selected data channel having the first timing maturity event occurrence are being output; and
controlling selection of the different one of the plurality of data channels having the second timing maturity event occurrence until the threshold number of packets is reached in the selected data channel.

6. The method of claim 5, wherein controlling selection of the different one of the plurality of data channels comprises providing control signals for each of the plurality of data channels indicating which of the plurality of data channels is available for selection, wherein a first control signal associated with a first data channel having the first timing maturity event occurrence is held logically low indicating passage of data stream packets from the first data channel is allowed and a second control signal associated with a second data channel having the second timing maturity event occurrence is held logically high indicating passage of data stream packets from the second data channel is restricted, and wherein the second control signal is held logically high until the threshold number of packets is reached in the first data channel.

7. The method of claim 3, further comprising resetting the specified counter value when the threshold number of packets is reached.

8. The method of claim 3, wherein the pace information comprises one of transmitter timestamp (TTS) values, program clock reference (PCR) values or descriptor timestamp values.

9. The method of claim 3, further comprising:
determining if a time distance is needed to retain between the consecutive transmission packets based on the pace information;
parsing the pace information from the overhead portion into separate data rate control configurations;
associating the separate data rate control configurations with respective ones of the consecutive transmission packets if the time distance is determined to be needed; and
controlling output of the stored data stream packets for corresponding ones of the consecutive transmission packets with the time distance between the consecutive transmission packets.

10. The method of claim 8, wherein retrieving the pace information comprises:
determining if TTS values are attached to the corresponding input data stream, wherein the TTS values indicate a time distance necessary to retain between the consecutive transmission packets;
parsing the TTS values from the overhead portion of the one or more of the stored data stream packets; and
associating the parsed TTS values with respective ones of the consecutive transmission packets, wherein the parsed TTS values comprise a plurality of transmitter transmission times.

11. The method of claim 10, wherein comparing the pace information comprises comparing the counter value with a specified transmitter transmission time against a respective one of the plurality of transmitter transmission times.

12. The method of claim 8, wherein retrieving the pace information comprises:
determining if PCR values are attached to the corresponding input data stream, wherein the PCR values indicate a time distance necessary to retain between the consecutive transmission packets;
parsing the PCR values from the overhead portion of the one or more of the stored data stream packets; and
associating the parsed PCR values with respective ones of consecutive transmission packets containing PCR values.

13. The method of claim 12, wherein comparing the pace information comprises comparing the counter value with a specified program control reference clock against a respective one of the parsed PCR values.

14. The method of claim 8, wherein retrieving the pace information comprises:
determining if the plurality of data stream packets are received with descriptor timestamp values, wherein the descriptor timestamp values indicate a time distance necessary to retain between consecutive data units of the corresponding input data stream, and wherein the descriptor timestamp values comprise a time at which a first data unit of the corresponding input data stream has to be released from the one or more packet buffers.

15. The method of claim 14, wherein comparing the pace information comprises comparing the counter value with a specified descriptor timestamp value against a respective one of the descriptor timestamp values.

16. The method of claim 3, wherein determining the timing maturity event occurrence comprises determining if a fixed counter value has expired and the specified counter value matches the pace information.

17. The method of claim 3, wherein determining the timing maturity event occurrence comprises determining if a fixed counter value has expired.

18. The method of claim 1, wherein the plurality of data stream packets comprise one of audio-video (AV) data, non-AV data, transport stream data or non-transport stream data.

19. A system for controlling data rates of individual streams, the system comprising:
a plurality of input data paths associated with respective ones of a plurality of data channels;
an output data path;
a plurality of packet buffers coupled to respective ones of the plurality of input data paths and configured to receive and store a plurality of data stream packets received via the respective ones of the plurality of input data paths, wherein the plurality of data stream packets of the respective ones of the plurality of data channels comprise an input data stream;
a plurality of control switches coupled to respective ones of the plurality of packet buffers and configured to, for each of the plurality of data channels, determine if a timing maturity event of a corresponding input data stream has occurred; and
a multiplexer coupled to outputs of the plurality of control switches and the output data path, the multiplexer configured to output one or more of the stored data stream packets from the one or more packet buffers associated with the respective data channel for generating a transmission packet if the timing maturity event of the corresponding input data stream has occurred,
wherein the stored data stream packets for generating consecutive transmissions packets are output at a data rate based on a distance between timing maturity event occurrences of the corresponding input data stream.

20. A computer program product comprising instructions stored in a tangible computer-readable storage medium, the instructions comprising:
instructions for receiving a plurality of data stream packets on respective ones of a plurality of data channels, wherein the plurality of data stream packets of the respective ones of the plurality of data channels comprise an input data stream;
instructions for storing the plurality of data stream packets for each of the respective ones of the plurality of data channels in one or more packet buffers associated with the respective data channel;
instructions for determining, for each of the plurality of data channels, if a timing maturity event of a corresponding input data stream has occurred; and
instructions for outputting one or more of the stored data stream packets from the one or more packet buffers associated with the respective data channel to generate a transmission packet if the timing maturity event of the corresponding input data stream has occurred,
wherein the stored data stream packets for generating consecutive transmissions packets are output at a data rate based on a distance between timing maturity event occurrences of the corresponding input data stream.
